(19) United States
(12) Patent Application Publication
(10) Pub. No.: US 2024/0261875 A1
(43) Pub. Date: Aug. 8, 2024

(54) DRILLING GUARD

(71) Applicant: Christian Pollner, Hamburg (DE)

(72) Inventor: Christian Pollner, Hamburg (DE)

(21) Appl. No.: 18/565,640

(22) PCT Filed: May 31, 2022
(86) PCT No.: PCT/EP2022/064743

§ 371 Date: Nov. 30, 2023

(30) Foreign Application Priority Data
Jun. 1, 2021 (DE) 10 2021 114 137.0

(51) Int. Cl. B23B 45/00; B23B 35/00

(52) U.S. Cl. CPC B23B 45/003; B23B 35/00; B23B 2260/122

(57) ABSTRACT

A drilling guard is provided for mounting on a drill head or a drill chuck of a drilling machine, in particular a cordless drill, for protecting the drilling surface against damage during drilling. A method for producing a borehole by using a drilling machine and the drilling guard is also provided.

### CROSS-REFERENCE TO EARLIER APPLICATION

This application claims priority to German patent application No. 10 2021 114 137.0 of Jun. 1, 2021, the contents of which are hereby incorporated by reference in their entirety.

### Field of the Invention

The invention relates to a drilling guard for mounting on a drill head or a drill chuck of a drilling machine, in particular a cordless drill.

### Background of the Invention

When drilling holes using drilling tools such as electric drilling machines and cordless drill drivers, also known colloquially as cordless screwdrivers, at high rotational speed or with excessive contact pressure, it can easily happen that the drilling surface is damaged by contact with the drill head or drill chuck of the tool.

Particularly with sensitive drilling surfaces such as hollow tile walls or wooden surfaces, it was previously only possible to reduce such damage to an acceptable level at the expense of the required working time with the help of practical experience and careful operation of the drilling tool.

It is therefore an objective of the present invention to provide a drilling guard which prevents damage to the drilling surface by drilling machines, thereby simplifying and accelerating the execution of drilling operations in sensitive drilling surfaces.

According to the invention, this objective is solved by the subject matters of the independent claims. Preferred and advantageous embodiments of the invention are the subject matters of the dependent claims and the following description.

### DESCRIPTION OF THE INVENTION

A drilling guard for mounting on a drill head or a drill chuck of a drilling machine is disclosed. The type of drilling machine is not particularly limited and can be an electrically operated machine tool or a hand tool. In particular, the drilling guard is configured for a cordless drill, also known as a cordless drill driver or “cordless screwdriver”.

The drilling guard comprises a disk-shaped damping member formed at least partially or completely of a shock-absorbing material and having a central through-hole provided for fitting the drilling guard over a drill bit inserted into the drill head. As used herein, the terms “disk” or “disk-shaped” refer to a geometric body which essentially has the shape of a flat cylinder and whose radius is several times or a multiple greater than its thickness. In particular, a disk according to the present invention has an outer radius that is several times or a multiple of an inner radius of the central through-hole.

Preferably, the outer radius of the disk-shaped damping member is at least 2-times, preferably at least 3-times, particularly preferably at least 4-times the inner radius of the central through-hole. The edges of the geometric body or the cylinder can be rounded. Accordingly, the “central through-hole” refers to a cut-out or bore, in particular a hollow cylindrical cut-out or bore, which is arranged in the geometric center of the disc-shaped damping member.

In addition, the drilling guard has a magnetic retaining member which is configured to magnetically fix the disk-shaped damping member to the drilling head during operation of the drilling machine.

The drilling guard according to the present invention can be used to safely absorb impacts that can occur when the drilling machine or drilling head strikes the drilling surface. In this way, tearing, scratching or breaking of the drilling surface can be effectively avoided even when drilling at high advancing speeds and forces. At the same time, the design of the drilling guard ensures universal applicability with a wide range of drill bits and drilling tools.

The magnetic retaining member is preferably an axially magnetized ring magnet or punched disc magnet, which is arranged concentrically around the central through-hole of the disc-shaped damping member. In this way, an evenly distributed magnetic holding force is generated, which ensures that the drilling guard is held reliably on the rotating drill head. A ring magnet is defined here as a punched disk magnet whose edge is several times thinner in relation to a central hole. “Axially magnetized” means that the direction of magnetization runs parallel to the longitudinal axis of the disc or ring and the poles are located on the circular disc or ring surfaces.

Alternatively, it is also possible to arrange two or more separate magnetic elements at preferably evenly spaced positions around the central through-hole of the disk-shaped damping member or to form the magnetic retaining member as a cylindrical magnet, which can be arranged at least partially within the central through-hole of the disk-shaped damping member.

In preferred embodiments, the magnetic retaining member is arranged on an underside of the disk-shaped damping member that faces the drill head. This one-sided arrangement of the magnetic retaining member on the underside of the damping member has the advantage that the retaining member is shielded from the drilling surface by the damping member and thus cannot contact the drilling surface during drilling and cause damage to the drilling surface, even at high drilling pressure. It is possible that the magnetic retaining member is integrated or at least partially embedded in the disk-shaped damping member. Preferably, the magnetic retaining member protrudes axially from the disk-shaped damping member in the direction of the drill head so that the magnetic retaining member and not the disk-shaped damping member makes contact with the drill head.

The connection between the magnetic retaining member and the disk-shaped damping member is not particularly limited and can be, for example, form-fit, force-fit or substance-fit. Any combination of these connection types is also possible. In preferred embodiments, the magnetic retaining member and the disk-shaped damping member are connected to each other by a material connection, in particular an adhesive connection. Alternatively, or additionally, the magnetic retaining member and the disk-shaped damping member can also be connected to each other by form-fit and/or force-fit connection, for example by pins, studs, rivets, screws or the like. Furthermore, the magnetic retaining member can also have axial and/or radial projections or protrusions that engage form-locking and/or friction-locking with the disk-shaped damping member. In this way, the magnetic retaining member is connected to the disc-shaped damping member in a particularly torsion-resistant manner, so that a high degree of mechanical robustness and reliable fixing of the drilling guard on the drill head is ensured even at very high rotational speeds of the drilling machine and large torsional moments, which can arise between the damping member and the magnetic retaining member, particularly at the moment when the damping member is contacting the drilling surface.

In preferred embodiments, the magnetic retaining member has a holing force or tensile force of at least four kilograms, preferably at least five kilograms, particularly preferably at least six kilograms. In further preferred embodiments, the holding force is at most ten kilograms, preferably at most nine kilograms, particularly preferably at most eight kilograms. A holding force in the range of six to eight kilograms is particularly advantageous, especially a holding force of around seven kilograms. In these ranges, a secure hold of the drilling guard on the drill head is ensured even when the drilling machine is operated at high rotational speeds. At the same time, the drilling guard can also be removed from the drill head easily and non-destructively after to use.

In preferred embodiments, the disc-shaped damping member has an outer diameter of at least 50 millimeters, preferably at least 60 millimeters, preferably at least 70 millimeters, particularly preferably at least 80 millimeters. In further preferred embodiments, the outer diameter of the disc-shaped damping member is at most 150 millimeters, preferably at most 140 millimeters, preferably at most 130 millimeters, particularly preferably at most millimeters. An outer diameter in the range of 80 millimeters to 120 millimeters is particularly advantageous, in particular an outer diameter of around 100 millimeters. In this way, a wide variety of drilling surfaces can be protected against damage particularly effectively by absorbing and distributing impulses over a large area without adversely affecting the operation of the drilling machine through high centrifugal forces or imbalance tendency of the drilling guard.

Preferably, the disk-shaped damping member or the shock-absorbing material has a thickness of at least eight millimeters in the axial direction, preferably at least ten millimeters. Furthermore, the disk-shaped damping member or the shock-absorbing material has a thickness in the axial direction of preferably at most 20 millimeters, preferably at most 18 millimeters. The thickness in the axial direction is preferably in the range of 13 millimeters to millimeters, in particular around 15 millimeters. This ensures reliable protection of the drilling surface without any disadvantages for the operation of the drilling machine.

The central through-hole of the disc-shaped damping member preferably has an inside diameter of at least ten millimeters, preferably at least eleven millimeters, particularly preferably at least twelve millimeters. The inner diameter of the central through-hole is preferably at most 15 millimeters, preferably at most 14 millimeters, particularly preferably at most 13 millimeters. A preferred inner diameter is about twelve millimeters. In this way, the drilling guard can be universally combined with different drill bit diameters and drill heads.

It is also possible that the central through-hole has different inside diameters in the axial direction. In particular, the inside diameter of the through-hole can be larger on the underside of the disc-shaped damping member than on the upper side so that, for example, parts of the clamping jaws of a drill chuck can be accommodated by the through-hole in order to ensure a flat fit of the drilling guard on the drill head. It is also possible that the larger diameter is used to accommodate the magnetic retaining member.

In preferred embodiments, a magnetic retaining member in the form of a ring magnet or punched disc magnet has an outer diameter of at least 20 millimeters, preferably of at least 25 millimeters, more preferably of at least 30 millimeters, particularly preferably about 35 millimeters and/or a central through-hole with an inner diameter of at least ten millimeters, preferably of at least twelve millimeters, more preferably of at least 15 millimeters, particularly preferably of at least 20 millimeters. The axial width or thickness of the ring magnet or punched disc magnet is preferably at least two millimeters, preferably at least four millimeters, more preferably at least six millimeters, particularly preferably at least eight millimeters, for example about ten millimeters. The bottom ring surface or disk surface configured for being placed on the drill head is preferably designed as a flat surface in order to ensure the largest possible and most uniform contact surface between the magnet and the drill head.

The magnetic retaining member is preferably a permanent magnet composed of a hard magnetic material such as an alloy of iron, aluminum, cobalt, bismuth, nickel, manganese, boron, neodymium and/or certain ferrites. Suitable permanent magnets are for example made of neodymium or ferrite.

In principle, the type of shock-absorbing material is not particularly limited. Natural and synthetic damping materials are suitable, such as various synthetic polymers, in particular in the form of foams, rubber, cork, felt, textiles or the like.

In preferred embodiments, the shock-absorbing material is a synthetic foam, in particular a synthetic rigid foam. Particularly preferably, the shock-absorbing material is a polyolefin foam, in particular a polyethylene foam (PE foam).

The synthetic foam or polyolefin foam preferably has a bulk density of at least 45 kilograms per cubic meter, preferably at least 50 kilograms per cubic meter, more preferably at least 55 kilograms per cubic meter, particularly preferably at least 60 kilograms per cubic meter. The density of a foam can be easily determined by a person skilled in the art, for example according to the regulation DIN EN ISO 845:2009-10 (issue date 10/2009). The bulk density is preferably at most 120 kilograms per cubic meter, more preferably at most 110 kilograms per cubic meter, particularly preferably at most 100 kilograms per cubic meter. A particularly preferred bulk density is in the range of 60 kilograms per cubic meter to 80 kilograms per cubic meter.

In preferred embodiments, the synthetic foam or polyolefin foam has a compression hardness at ten percent deformation of at least 60 kilopascals, at least 80 kilopascals, at least 100 kilopascals or at least 120 kilopascals.

Compression hardness is the force in Newtons (N) physically acting on a surface in square meters, which can be determined in compression tests, e.g. in accordance with DIN EN ISO 844:2014-11 (issue date 11/2014). In further preferred embodiments, the compression hardness at ten percent deformation is at most 200 kilopascals, preferably at most 180 kilopascals, more preferably at most 160 kilopascals, particularly preferably at most 140 kilopascals.

Within the aforementioned ranges, the synthetic foam combines advantageous damping properties with advantageous mechanical stability, so that the disk-shaped damping member can be configured, for example, in the form of a self-supporting foam disk, i.e. consisting solely of the shock-absorbing material. This allows a particularly simple, lightweight and cost-effective design of the drilling guard. At the same time, the synthetic foam leaves no abrasion or scratches or markings on the drilling surface, even at high rotational speeds and high contact pressure.

In preferred embodiments, the disk-shaped damping member is constructed to be self-supporting from the shock-absorbing material. As the term is used here, “self-supporting” means having form stability without additional supports, carriers or the like, in particular without an abutment acting in the direction of the drill head. However, it is of course also possible for the disk-shaped damping member to be constructed in several parts and to have, for example, a carrier disk which serves as an axial abutment in the direction of the drill head and on whose surface facing away from the drill head the shock-absorbing material is arranged.

In particularly preferred embodiments, the shock-absorbing material is a cross-linked polyethylene foam (XPE foam). It has been found that the use of XPE foams can advantageously reduce the friction between the drilling guard and the drilling surface, so that no damage is caused to the drilling surface, the drilling guard or the gearbox of the drilling machine when the drilling guard contacts the surface. In addition, plasticization of the damping material due to frictional heat is prevented. XPE foams also have an advantageous elasticity and mechanical stability, which together ensure a simple structure of the damping member and reliable protection of the drilling surface against damage, even at high contact pressure and high rotational speeds.

In preferred embodiments, an outer side of the damping member facing away from the drill head is at least partially forming a contact surface, which closes off the drilling guard axially in outward direction, i.e., the contact surface forms an axial end of the drilling guard on the side facing away from the drill head. The contact surface is thus configured to contact the drilling surface, i.e., no other elements of the drilling guard or the drilling machine are arranged between the damping member or the contact surface and the drilling surface during operation. The drilling surface is therefore particularly well protected against damage.

In the aforementioned embodiments, the drilling guard can be used with advantage to protect drilling surfaces against damage caused by a drilling machine during drilling.

A method according to the present invention for producing a borehole in a drilling surface using a drilling machine, in particular a cordless drill, comprises the following steps: inserting a drill bit into the drilling head of the drilling machine, mounting a drilling guard as described above over the drill bit and magnetically fixing the drilling guard to the drilling head, operating the drilling machine in order to produce the borehole. The method has the advantage that drilling can be carried out at high rotational speeds and with high advancing forces without the risk of damaging the drilling surface. In this way, drilling can be simplified and accelerated even on sensitive drilling surfaces.

### BRIEF DESCRIPTION OF THE FIGURES

The invention is explained in more detail below with reference to the enclosed figures. These are merely schematic representations of the principle, not drawn to scale, and are to be understood as examples only. The invention is in no way intended to be limited to the embodiments and the figures shown. Unless otherwise indicated, identical reference signs stand for identical or analogous elements. The figures show

FIG. 1 a schematic sectional view of an embodiment of a drilling guard according to the present invention mounted on the drill head of a drilling machine;

FIG. 2 a further embodiment of a drilling guard according to the present invention in a schematic sectional view;

FIG. 3 a further embodiment of a drilling guard according to the invention in a schematic sectional view.

### DETAILED DESCRIPTION OF EMBODIMENTS

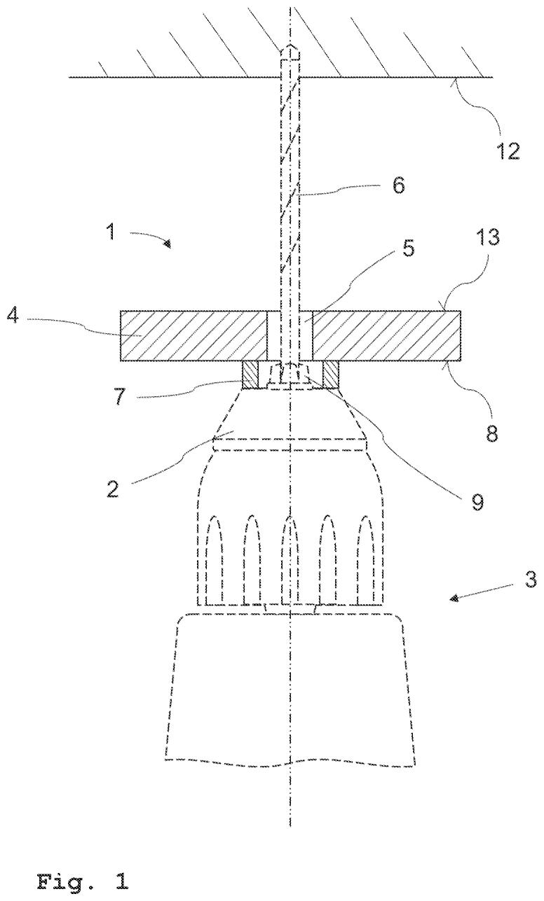

FIG. 1 shows a sectional view of an exemplary embodiment of a drilling guard 1 according to the present invention, which is mounted on the drilling head 2 of a drilling machine 3 (not shown in detail) in order to protect the drilling surface 12 from damage.

The drilling guard 1 comprises a disc-shaped damping member with an outer diameter of approximately 100 millimeters and a thickness of approximately 15 millimeters. In the middle of the disc is the central through-hole 5 with an internal diameter of approximately 12 millimeters, through which the drill bit 6 mounted in the drill head 2 is passed.

In the example shown, the disc-shaped damping member 4 is formed from an XPE rigid foam (e.g., XPE 60) with a gross weight of approximately 60 kilograms per cubic meter and a compression hardness at 10% deformation of approximately kilopascals as a shock-absorbing material. In this embodiment, the rigid foam disk is self-supporting, so that the disk-shaped damping member 4 can consist exclusively of the shock-absorbing material. This enables a particularly simple and lightweight design of the drilling guard 1, which does not adversely affect the operation of the drilling machine 3 as a result of favorable dynamic behavior due to low mass, low rotational moment of inertia, low imbalance tendency and a compact design.

It is of course also possible to use softer shock-absorbing materials, which may be arranged on a suitable support structure not shown here, such as a synthetic support disk, to form the disk-shaped damping member 4.

A magnetic retaining member 7, which in the example shown is formed by a ring magnet with an outer diameter of approximately 35 millimeters, an inner opening diameter of approximately 24 millimeters and a ring width or height of approximately 10 millimeters, is arranged on the underside 11 of the disc-shaped damping member 4 facing towards the drill head 2. The disk-shaped damping member 4 and ring magnet 7 are arranged concentrically. Because the inner opening diameter of the ring magnet 7 in the example shown is larger than the inner diameter of the central through-hole 5, parts of the chuck jaws 9 protruding from the drill head 2 can be accommodated in the ring opening. In this way, a flat seat of the drilling guard 1 on the drill head is ensured.

The ring magnet 7 is bonded to the disc-shaped damping member 4 using an adhesive.

The ring magnet 7 is made of neodymium N44. The holding force of the ring magnet 7 is approximately seven kilograms, which ensures that the damping member 4 is held rotationally fixed during operation of the drilling machine and at the same time makes it easy to attach and remove the drilling guard 1.

The outer side of the disk-shaped damping member 4 facing away from the drill head 2 forms the contact surface 13, which closes off the drilling guard in an axial direction according to the outside and is configured to contact the drilling surface during the drilling process as the only element of the drilling guard.

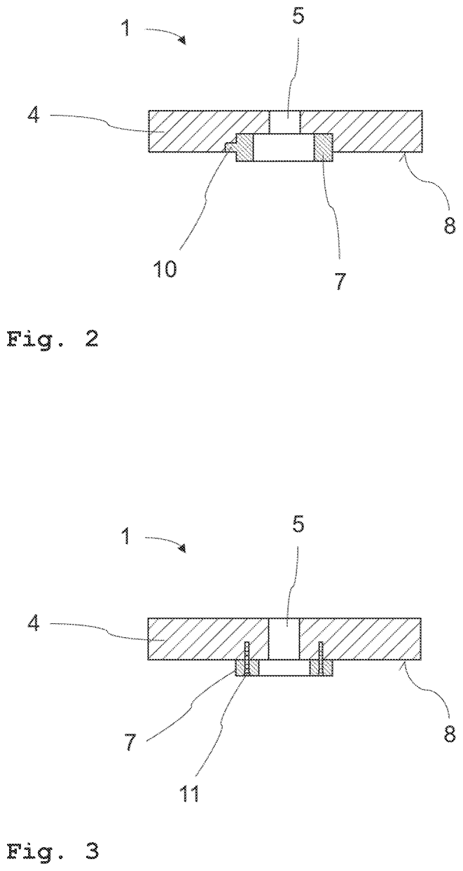

FIG. 2 shows a further possible embodiment of the drilling guard 1 according to the present invention. In the example shown, the magnetic retaining member 7, which is formed as a ring magnet, is partially embedded in the disc-shaped damping member 4 on the underside 8. A protrusion 10 that protrudes radially from the ring magnet 7 engages in the disk-shaped damping member 4, thereby preventing the ring magnet 7 and the damping member 4 from being twisted against each other. It is understood that the ring magnet 7 can also have several such protrusions 10. In addition, such protrusions can of course also protrude axially from the ring magnet 7 and engage in the disk-shaped damping member 4.

Finally, FIG. 3 shows another possible embodiment of the drilling guard 1 according to the present invention. In this case, the magnetic retaining member 7 is a punched disk magnet, which is connected to the disk-shaped damping member 4 in a rotationally fixed manner by means of of fastening elements 11, e.g., bolts or screws. The fastening elements 11 are recessed in the punched disk magnet 7 in such a way that there is a flat contact surface for placing on the drill head 2.

The invention is not limited to the described examples. Rather, the invention includes every new feature as well as every combination of features, which includes in particular every combination of features in the patent claims, even if this feature or this combination of features is not itself explicitly described in the patent claims or the examples.

### LIST OF REFERENCE SYMBOLS

1 drilling guard
2 drill head
3 drilling machine
4 disk-shaped damping member
5 central through-hole
6 drill bit
7 magnetic retaining member
8 underside
9 clamping jaws
10 protrusion
11 fastening element
12 drilling surface
13 contact surface.

1-15. (canceled)

16. A drilling guard for mounting on a drill head of a drilling machine, the drilling guard comprising:
a disk-shaped damping member being at least partially formed from a shock-absorbing material, said disk-shaped damping member having a central through-hole formed therein for mounting the drilling guard over a drill bit inserted into the drill head; and
a magnetic retaining member configured to magnetically fix said disk-shaped damping member to the drill head during operation of the drilling machine.

17. The drilling guard according to claim 16, wherein said magnetic retaining member is an axially magnetized ring magnet or punched disc magnet disposed concentrically around said central through-hole of said disc-shaped damping member.

18. The drilling guard according to claim 16, wherein said disc-shaped damping member has an underside directed towards the drill head, and said magnetic retaining member has one side disposed on said underside.

19. The drilling guard according to claim 16, wherein said magnetic retaining member is at least partially embedded in said disc-shaped damping member.

20. The drilling guard according to claim 16, wherein said magnetic retaining member has a magnetic holding force of at least 4 kilograms and at most kilograms.

21. The drilling guard according to claim 16, wherein said disk-shaped damping member has an outer radius being a multiple of an inner radius of said central through-hole.

22. The drilling guard according to claim 16, wherein said disk-shaped damping member has an outer diameter of at least 50 millimeters and at most 150 millimeters.

23. The drilling guard according to claim 16, wherein said central through-hole has an inner diameter of at least ten millimeters and at most 15 millimeters.

24. The drilling guard according to claim 16, wherein said disk-shaped damping member or said shock-absorbing material has a thickness of at least 10 millimeters and at most 20 millimeters along an axial direction.

25. The drilling guard according to claim 16, wherein said shock-absorbing material includes or consists of a polyolefin foam.

26. The drilling guard according to claim 25, wherein said polyolefin foam has a bulk density of at least 45 kilograms per cubic meter and at most 100 kilograms per cubic meter.

27. The drilling guard according to claim 25, wherein said polyolefin foam has a compression hardness at 10% deformation of at least 60 kilopascals and at most 200 kilopascals.

28. The drilling guard according to claim 16, wherein said shock-absorbing material causes said disk-shaped damping member to be self-supporting.

29. The drilling guard according to claim 16, wherein said disk-shaped damping member has an outer side facing away from the drill head and a contact surface on said outer side, said contact surface being a termination of the drilling guard outwards in axial direction and being configured to engage against a drilling surface.

30. The drilling guard according to claim 16, wherein the drilling guard consists of said disk-shaped damping member and said magnetic retaining member.

31. The drilling guard according to claim 16, wherein the drilling machine is a cordless drill.

32. A method for producing a borehole by using a drilling machine, the method comprising:
inserting a drill bit into a drill head of the drilling machine;
fitting the drilling guard according to claim 16 over the drill bit and magnetically fixing the drilling guard to the drill head; and
operating the drilling machine to produce the borehole.

33. The method according to claim 32, which further comprises providing a cordless drill as the drilling machine.
